(19) United States
(12) Patent Application Publication
(10) Pub. No.: US 2008/0317395 A1
(43) Pub. Date: Dec. 25, 2008

(54) Bearing Arrangement

(75) Inventors: Werner Hartmann, Vaihingen/Enz (DE); Martin Wellhausser, Sersheim (DE); Christof Heuberger, Markgroningen (DE); Siegfried Stefani, Oberriexingen (DE)

Correspondence Address: OSHA LIANG L.L.P., TWO HOUSTON CENTER, 909 FANNIN, SUITE 3500, HOUSTON, TX, 77010, US

(73) Assignee: VALEO SYSTEMES D'ESSUYAGE, Le Mesnil-Saint-Denis (FR)

(21) Appl. No.: 11/994,303

(22) PCT Filed: Jun. 29, 2006
(86) PCT No.: PCT/EP06/06337

§ 371 Date: Jun. 27, 2008

(30) Foreign Application Priority Data
Jun. 29, 2005 (DE) 10 2005 030 237.8
Mar. 20, 2006 (DE) 10 2006 012 612.2

(51) Int. Cl. F16C 35/00

(52) U.S. Cl. 384/428

(57) ABSTRACT

A bearing arrangement for a shaft of an electric auxiliary motor for vehicles, wherein the shaft with a shaft end reaches through one of a housing opening and a through opening into a chamber formed in a gearbox housing, wherein the shaft is supported in a bearing bush which lies against a surface on the abutment side surrounding the through opening and wherein the bearing bush is fixed in the chamber by a filling body made of a hardened filling mass scaling the chamber from the outside inwards, wherein the chamber is equipped with at least one of a fixing surface and a sealing surface surrounding the axis of the shaft, against which the filling body is pressed as a result of shrinkage of the hardened filling mass upon hardening.

The invention refers to a bearing arrangement according to the generic term of patent claim 1.

An electric auxiliary drive for functional elements of a vehicle particularly involves, in the sense of the invention, a drive for windscreen wipers or windscreen wiper modules, but also a drive for opening and closing a vehicle window, a sliding roof or for folding in or out of vehicle mirrors, etc.

Specifically in the case of electric drives for windscreen wipers, it is known (DE 101 17 573) to provide the motor or rotor shaft of the electric motor with multiple bearings and indeed with a primary or main bearing in the motor and gearbox housing respectively and with a bearing arrangement for shaft end distant from the motor forming an additional bearing. For this bearing arrangement, the gearbox housing has a chamber open to the gearbox outer side, wherein the end of the shaft reaches from the inside of the gearbox housing through a through opening and in which a bearing bush closed to the open side of the chamber is provided to support the end of the shaft, which (bush) is fixed in the chamber after mounting on the end of the shaft by application of a hardening or setting fixing or filling mass.

Suitable fixing or filling masses available have the property of considerably shrinking or shrivelling on hardening or setting, which may result in faulty sealing of the gearbox housing in the area of the bearing arrangement.

The purpose of the invention is to demonstrate a bearing arrangement with improved properties, particularly also with regard to the sealing of the gearbox housing.

In order to fulfil this task, a bearing arrangement according to patent claim 1 is illustrated.

In the invention, the shrinking of the fixing or filling material during hardening or shrinking is used in order to connect the fixing and filling body formed by this material particularly firmly and tightly to the gearbox housing and to be more precise due to the fact that at least a fixing and sealing surface is provided in the chamber such that the material of the fixing and filling body surrounding this surface lies firmly and permanently elastically against this surface.

In one embodiment of the invention, a sleeve-like bush open at both ends is used, so that when introducing the fixing and filling mass in the chamber, this mass can also partially emerge in the bearing bush to the end of the shaft there, as a result of which the fixing and filling mass, on setting, forms a section of the filling body reaching into the bearing bush as axial support for the shaft.

Further developments of the invention are the subject of the subclaims. The invention is explained in further detail below in examples of embodiment based on the figures.

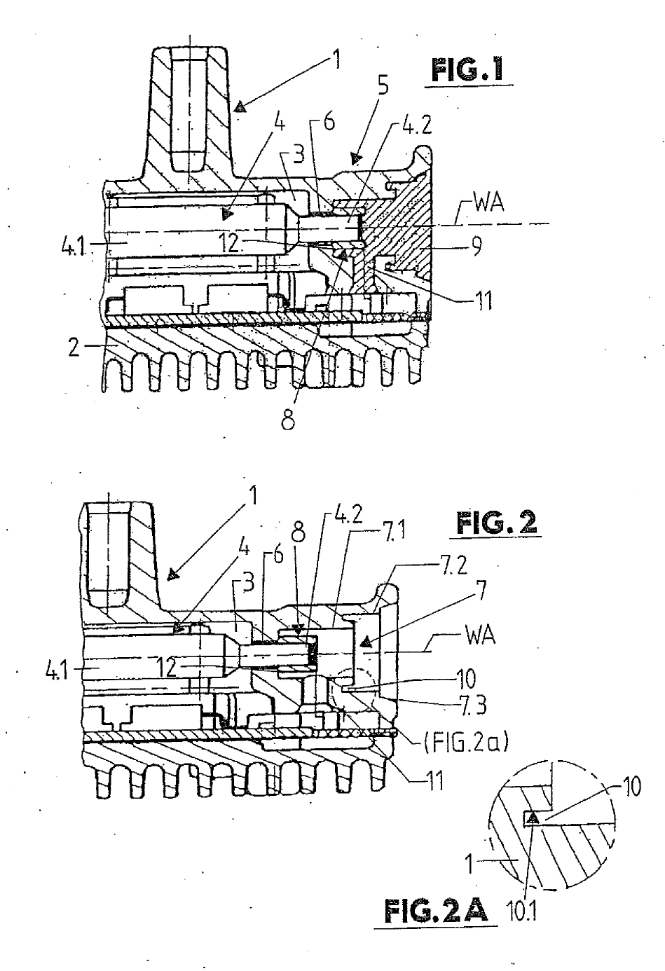

FIG. 1 shows a simplified representation of a partial section through the gearbox housing of and electric auxiliary drive in the area of a bearing arrangement forming an additional support bearing according to the invention;

FIG. 2 shows a view as in FIG. 1, but before introduction of the fixing and filling mass;

FIG. 2a shows an enlarged section of FIG. 2

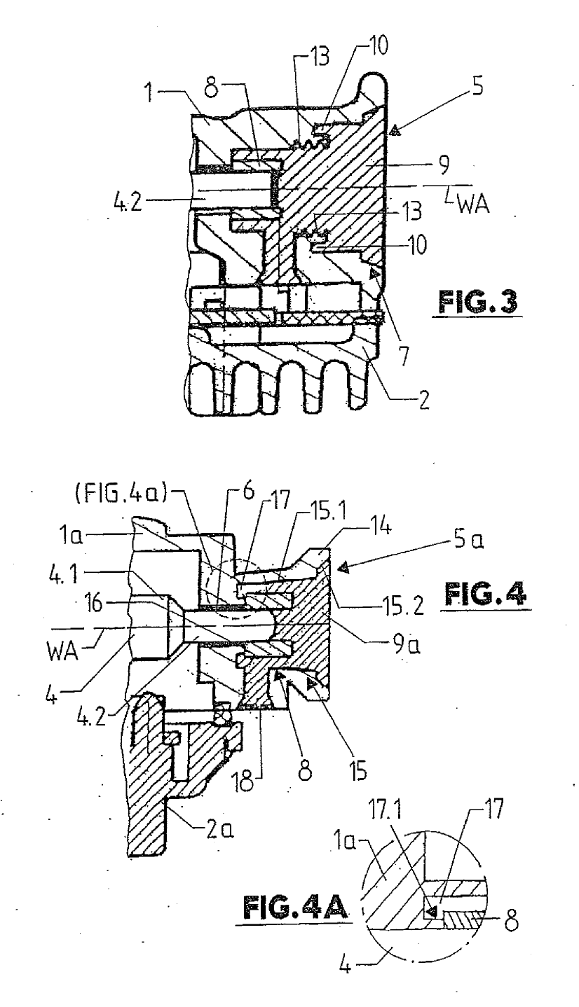

FIG. 3-4 shows further possible embodiments of the bearing arrangement in representations similar to FIG. 1 respectively;

FIG. 4a shows an enlarged section of FIG. 4, but without the filling body;

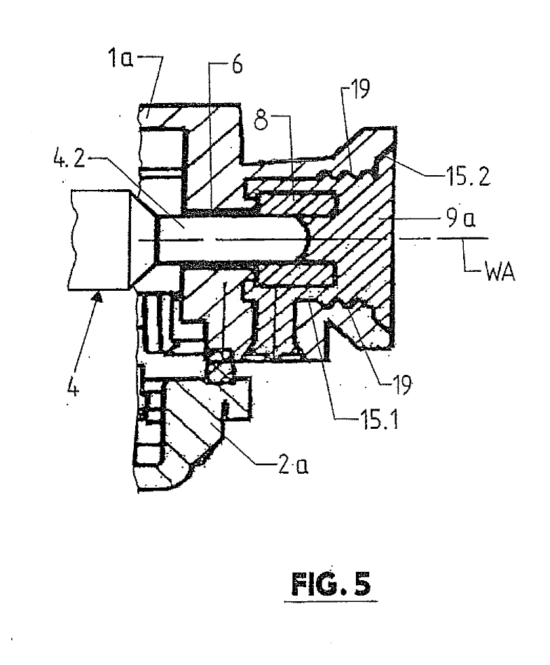

FIG. 5 shows a further possible embodiment of the bearing arrangement in presentations similar to FIG. 1;

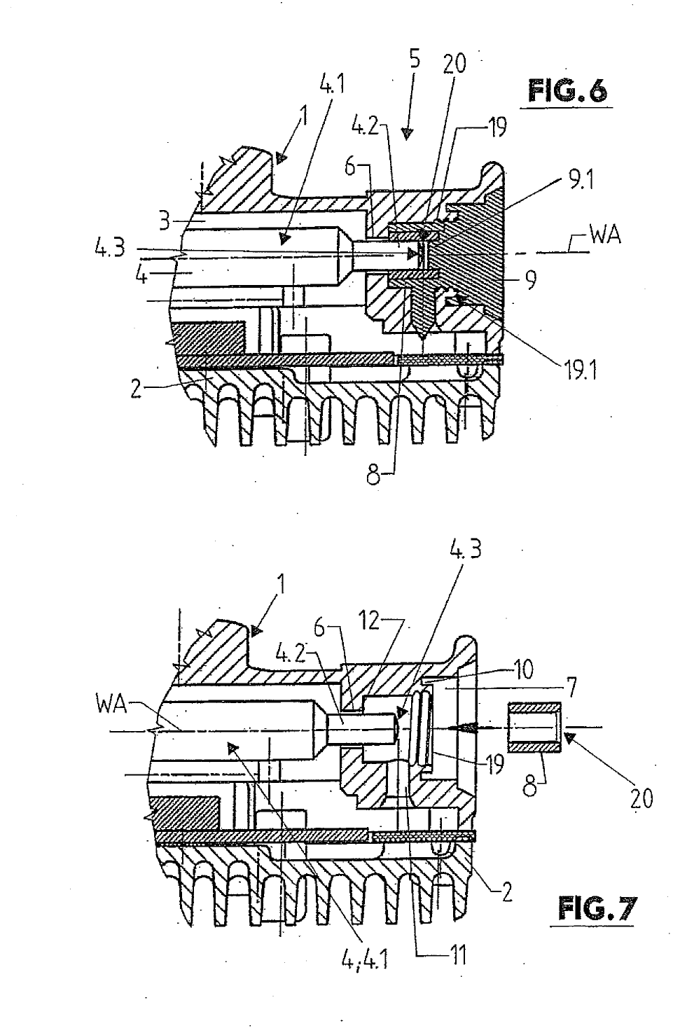

FIG. 6-9 shows a further embodiment of the invention with the use of a stop disc.

In FIGS. 1 to 3, the gearbox housing is that of an electric auxiliary motor, for example a windscreen wiper drive. A motor or rotor shaft 4 is received over part of its length in the inner chamber 3 closed by a cover 2 of the gearbox housing 4. In the motor housing not illustrated in FIG. 1 to 3 flanged to the gearbox housing 1 and also in the gearbox housing 1, for example in the area of connection with the motor housing, the shaft 4 is supported by two primary bearings (e.g. ball bearings) which are not illustrated, so that after mounting the motor on the gearbox housing 1, the necessary alignment of the rotor shaft 4 and its axis RA already exists. In the inner chamber 3, the rotor shaft 4 is provided with a worm gear 4.1 which interacts with a non-illustrated worm wheel on a likewise non-illustrated output shaft of the gear supported in the gearbox housing 1.

The free shaft end 4.2 of the rotor shaft distant from the motor represented in FIG. 1 is supported in a bearing arrangement 5 forming an additional support bearing. For this purpose, the shaft end 4.2 reaches through a housing or through opening 6, the cross-section of which is slightly larger than the outside cross-section of the shaft end 4.2, into a relatively large volume chamber 7 formed in the gearbox housing 1 and open to the outer surface of the gearbox housing, in which a sleeve-like, bearing bush 8 open at bot h ends and made of a material suitable for bearing bushes, for example metal, is arranged on the shaft end 4.2. The chamber 7 is completely filled in with a suitable hardening fixing or filling mass, for example with a suitable thermoplastic synthetic material. This mass forms an insert or fixing or filling body 9 after hardening or setting, by means of which not only the bearing bush 8 arranged on the shaft end 4.2 is fixed to the gearbox housing 1, but also the gearbox housing 1 is closed with an absolutely watertight seal in the area of the bearing arrangement 5.

In the embodiment represented in FIGS. 1 and 2, the chamber 7 is realised in such a manner that adjacent to the through opening 6 in the direction of the axis RA, it initially forms a circular cylinder-shaped or roughly circular cylinder-shaped section 7.1 concentrically surrounding this axis, to which a likewise circular cylinder-shaped or roughly circular cylinder-shaped section 7.2 in addition to a cone-shaped widening section 7.3 are subsequently connected, with the widening section 7.3 forming the opening of the chamber 7 on the outer surface of the gearbox housing 1. The diameter of section 7.1 is larger than the diameter of the through opening 6 and also larger than the external diameter of the bearing bush 8. Furthermore, the axial length of section 7.1 is larger than the axial length of the b ear ing bush 8. Section 7.2 has a diameter larger than that of section 7.1, but in the same manner as section 7.3 has an axial length that is considerably smaller than the axial length of section 7.1.

In the stage or ring area forming the transition between sections 7.1 and 7.2, a circumferential groove 10 is incorporated, concentrically surrounding the axis RA and open in the direction to section 7.2, which forms with its side near to the RA axis a fixing and sealing surface 10.1 (FIG. 2a), as will be further described below. Furthermore, a channel 11 leading into section 7.1 of chamber is provided in the gearbox housing 1, the longitudinal axis of which lies radially to the axis RA and which is open on the side of the gearbox housing 1 closed by the cover 2.

During installation of the drive, the motor preassembled with the rotor shaft 4 is connected to the gearbox housing 1, so that the rotor shaft 4 is already arranged by the two main bearings with its axis RA aligned in the necessary manner in the gearbox housing 1. On the shaft end 4.2 passed through the through opening, the bearing bush is subsequently applied from the open side of the chamber 7, which is readily possible owing to the larger dimension of section 7.1 in comparison to the external diameter of the bearing bush in addition to the large opening cross-section of the chamber 7 on the outer side of the gearbox housing 1. The bearing bush 8 is applied in this case in such a way that it lies with its abutting face towards the through opening 6 firmly against a circular flange 12 formed at the transition between the through opening 6 and the chamber 7, so that the through opening 6 is sealed against the inside of the chamber 7. The installation status presented in FIG. 2 is thereby achieved.

The chamber 7, circumferential groove 10 and channel 11 are subsequently completely filled in with the filing mass forming the filling body 9 and to be more precise by use for example of a suitable injection moulding tool. Owing to the shrinkage occurring during hardening or setting, the filling mass deposits itself particularly firmly and tightly on the inner surface of this circumferential groove 10 situated closer to the RA axis on the inner surface of the chamber 7, so that the transition between the inner surface of the chamber 7/filling body 9 in the course between the open side of the chamber 7 and the through opening 6 is tightly closed, also in particular with a watertight seal. The inner surface of the circumferential groove 10 closer to the axis RA to be seen in FIG. 2a essentially forms the fixing or sealing surface 10.1.

By means of the channel 11 and the portion of the hardened filling mass taken up in this channel, the filling body 9 with the bearing bush embedded in this filling body is held secure against torsion in the gearbox housing 1. Since furthermore the bearing bush 8 is open at both ends in the embodiment presented, the filling mass penetrates over the open end to the exposed surface of the shaft end 4.2 in the bearing bush 8 so that axial support of the rotor shaft within the bearing bush is also achieved following hardening of the filling mass.

FIG. 3 shows an embodiment that only differs from the embodiment in FIGS. 1 and 2 in that the chamber 7 is profiled on the inside surface and to be more precise specifically on the inside surface of section 7.1 in this embodiment, equipped with a threaded section 13 form example, in order to achieve additional anchoring of the filling body 9.

FIG. 4 shows a simplified representation of a gearbox housing 1a of an electric auxiliary motor with a cover 2a and a bearing arrangement 5a for the shaft end 4.2 of the rotor shaft 4. In this embodiment also, the shaft end 4.2 reaches through the through opening 6 into a chamber 15 corresponding to chamber 7 formed on a housing section 14 and is supported there by a bearing bush 8, which is fixed in turn by the filling body 9a that completely fills in the chamber 15. The chamber 15 open on the housing outer side is designed in such a manner in this embodiment that in the direction of the axis RA following the through opening 6, it initially has a slightly truncated cone-shaped section 15.1 increasing in size towards the open end of chamber 15 and subsequently a section 15.2 that further widens and forms the opening of the chamber 15. The internal diameter of section 15.1 is in turn larger than the external diameter of the bearing bush 8 open at both ends and also considerably larger than the diameter of the through opening 6. On the ring area 16 forming the transition between the through opening and section 15.1, circularly surrounding the RA axis and arranged in a plane vertical to this axis, a groove 17 is made, concentrically surrounding the axis RA and open to the chamber 15 and indeed in such a way that even with the bearing bush 8 in tight contact on the abutment face against the ring area 16, the circumferential groove 17 is still open to the chamber 15 (refer also to FIG. 4a). In this embodiment also, a channel 18 leading into the chamber 15 is in turn provided.

After installation of the motor not illustrated in the drawing with the rotor shaft 4 on the gearbox housing 1a, the bearing bush 8 is applied to the shaft end 4.2 reaching through the through opening 6 into the chamber and indeed in such a way that the bush is in contact with the abutment face against the ring surface 16 and seals of the through opening 6 to the chamber 15. The inside of the chamber 15, including the groove 17 and the channel 18, is subsequently filled in with the filling mass, for example thermoplastic filling mass, forming the filling body 9a.

After hardening of the filling mass, a particularly firm and also especially sealed transition between the filling body 9a and the gearbox housing 1a is achieved in the area of the internal circular side area of the groove 17 and to be more precise by means of shrinkage of the material forming the filling body 9a. The internal circular side area of the groove 17 forms in this case the fixing or sealing surface 17.1 better recognisable in FIG. 4a. As a result of the section of the filling body 9 taken up in the channel 18, the former also has torque-proof anchoring in the chamber. Furthermore, the filling body 9a also forms an axial support for the shaft end 4.2 in the bearing bush 8 and to be precise by means of the filling material which has penetrated there.

FIG. 5 shows a further embodiment that essentially only differs from the embodiment in FIG. 4 in that the internal surface of the chamber 15 is profiled and equipped with a threaded section 19 in order to achieve as a result additional anchoring of the filling body 9a.

The example of embodiment presented in FIGS. 6-9 essentially corresponds to the example of embodiment presented in FIG. 3 with the description elements referring to it, which also refer in turn in further areas to the example of embodiment according to FIGS. 1, 2 and 2a and the corresponding description. Consequently, the same references will also be used in FIGS. 6-9 for identical or comparable components and details. In order to avoid repetitions, the description of this example of embodiment primarily refers to the differences in relation to the other examples of embodiment.

The essential difference lies in case of the example of embodiment in FIGS. 6-9 in that a stop disc 20 is arranged here within the bearing bush 8 between the front face 4.3 of the shaft end 4.2 and the segment 9.1 of the filling body 9 projecting into the bearing bush 8. The stop disc 20 is generally made of metal, though steel is preferred. In cases with special stresses, the stop disc can also be manufactured from ceramic. Within the bearing arrangement 5, this stop disc 20 lies free of play against the front face 4.3 of the shaft end 4.2 and is in turn supported by the segment 9.1 of the filling body 9 projecting into the bearing bush 8. In addition to the secure fixing of the bearing bush 8 and the watertight closure of the bearing arrangement 5 by the injected filling body 9, this measure also achieves a hold free of axial play for the rotor shaft in addition to low-friction running of the rotor shaft 4 on this axial support. The friction acting between the front face 4.3 and the stop disc 20 on rotation of the rotor shaft 4 is further reduced if the front face 4.3 of the shaft end 4.2 and/or the stop disc 20 is designed for a mutually punctiform arrangement. Furthermore, the front face 4.3 of the shaft end 9.1 is preferably convex in shape, with above all a spherical or spherical segment-shaped design being used. Alternatively or in addition, the stop disc 20 may have a convex shape towards the front face side 4.3.

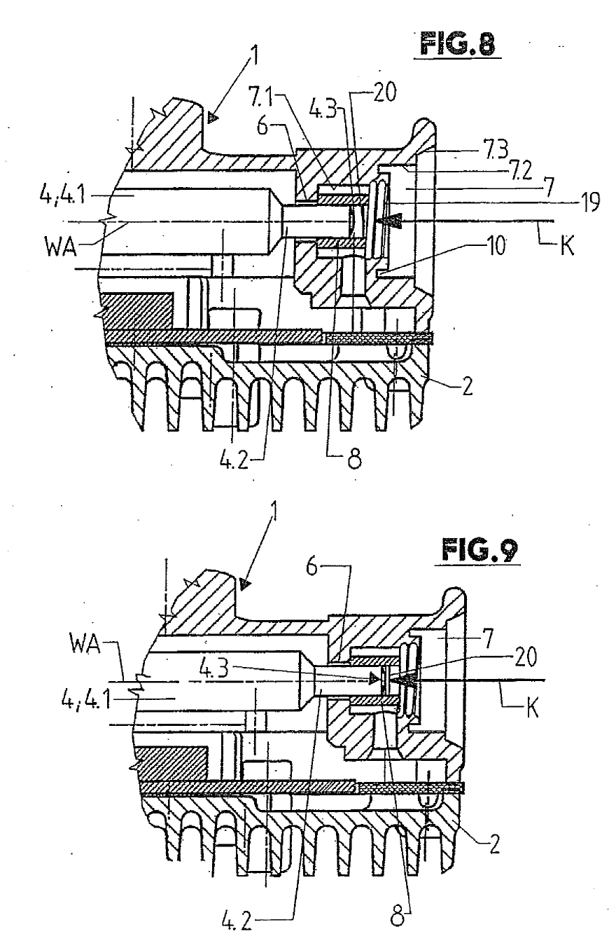

In FIG. 7, the bearing bush 8 is illustrated in a pre-installation condition. The stop disc 20 is pressed into the end of the bearing bush distant from the front face 4.3 of the shaft end 4.2, such that it is tensioned on the inner side of the bearing bush. The bearing bush 8 is furthermore pushed axially on to the shaft end 4.2 until, as shown in FIGS. 8 and 9, it lies with its internal front face on the ring surface 12 which surrounds the through opening 6. The stop disc 20 is now pushed axially inwards to the stop against the front face 4.3 of the shaft end 4.2 with a force F that overcomes the tensioning force of the stop disc in the bearing bush. As a result of the force F with which the stop disc 20 is pressed against the front face, the axial play of the rotor shaft is also eliminated. At this stage, the filling mass is injected into the chamber 7 in the manner already described in the other examples of embodiment so that after setting of the filling mass, the filling body 9 already described and presented in FIG. 6 with its segment 9.1 projecting into the bearing bush 8 is formed.

Special attention is furthermore drawn to the fact that several fixing and sealing surfaces may be provided on the same bearing arrangement, onto which the filling material shrinks to form a seal on setting or hardening. In particular, a fixing or sealing surface according to the embodiment in FIGS. 1, 2 and 2a and a fixing or sealing surface according to the embodiment in FIGS. 4 and 4a may be realised at one and the same bearing position.

The invention has been described above based on examples of embodiment. It is understood that many modifications and alterations are possible without forasmuch departing from the conception behind the invention.

It was therefore assumed above that the fixing or filling mass is a thermoplastic. Use of other materials is fundamentally possible, for example non-thermoplastic synthetic materials or low-melt-point metal alloys.

### LIST OF REFERENCES

1, 1a Gearbox housing
2, 2a Cover
3 Gearbox interior
4 Rotor shaft
4.1 Worm gear on rotor shaft
4.2 Shaft end
4.3 Front face
5, 5a Bearing arrangement
6 Through opening
7 Chamber
7.1, 7.2, 7.3 Section of chamber 7
8 Bearing bush
9, 9a Filling body
9.1 Segment
10 Circumferential groove
10.1 Fixing or sealing surface
11 Channel
12 Ring area or flange
13 Threaded section
14 Section of the housing 1a
15 Chamber
15.1, 15.2 Section of the chamber
16 Ring area or flange
17 Circumferential groove
17.1 Fixing or sealing area
18 Channel
19 Threaded section
20 Stop disc
F Force
RA Rotor axis

1. A bearing arrangement for a shaft of an electric auxiliary motor for vehicles, wherein the shaft with a shaft end reaches through one of a housing opening and a through opening into a chamber formed in a gearbox housing, wherein the shaft is supported in a bearing bush which lies against a surface on the abutment side surrounding the through opening and wherein the bearing bush is fixed in the chamber by a filling body made of a hardened filling mass sealing the chamber from the outside inwards, wherein the chamber is equipped with at least one of a fixing surface and a sealing surface surrounding the axis of the shaft, against which the filling body is pressed as a result of shrinkage of the hardened filling mass upon hardening.

2. The bearing arrangement according to claim 1, wherein the one of the fixing and sealing surface is a surface facing away from the axis of the shaft.

3. The bearing arrangement according to claim 1, wherein the one of the fixing and sealing surface is provided at a transition between the filling body and the internal surface of the chamber and in the course of the transition between an open side of the chamber and the through opening.

4. The bearing arrangement according to claim 1, wherein the one of the fixing and sealing surface surrounds the shaft axis concentrically.

5. The bearing arrangement according to claim 1, wherein the chamber has at least two sections of different diameters, wherein each of the at least two sections adjoins the other in the direction of the shaft axis.

6. The bearing arrangement according to claim 5, wherein the one of the fixing and the sealing surface is formed by a radial internal side area of a groove surrounding the shaft axis.

7. The bearing arrangement according to claim 6, wherein the groove forming the one of the fixing and sealing surface is provided at a transition between the at least two sections of the chamber.

8. The bearing arrangement according to claim 6, wherein the groove forming the one of the fixing and sealing surface is provided on an area surrounding the through opening.

9. The bearing arrangement according to claim 1, wherein the chamber is profiled on at least a portion of an internal surface of the chamber, wherein the chamber is provided with at least one threaded section.

10. The bearing arrangement according to claim 1, further comprising at least one channel leading into the chamber, wherein the at least one channel is filled with the filling mass forming the filling body.

11. The bearing arrangement according to claim 10, wherein the at least one channel leads into the chamber radially with reference to the shaft axis.

12. The bearing arrangement according to claim 10, wherein the at least one channel is open to a side of the gearbox housing, wherein the side of the gearbox housing is closed with a cover.

13. The bearing arrangement according to claim 3, wherein the chamber has an increasing cross-section towards the open side.

14. The bearing arrangement according to claim 13, wherein the chamber widens in one of a funnel shape and a truncated cone shape on the open side.

15. The bearing arrangement according to claim 1, wherein the chamber is formed by at least one of a cylindrical and a truncated cone-shaped section concentrically surrounding the shaft axis.

16. The bearing arrangement according to claim 1, wherein the bearing bush is designed as a bush open at both ends and wherein a segment of the filling body projects into the end of the bearing bush facing away from the through opening, forming an axial support for the shaft.

17. The bearing arrangement according to claim 16, wherein a stop disc is arranged within the bearing bush between a front face of the shaft end and the segment of the filling body projecting into the bearing bush.

18. The bearing arrangement according to claim 17, wherein the stop disc supported by the segment of the filling body projecting into the bearing bush lies free of play against the front face of the shaft end.

19. The bearing arrangement according to claim 17, wherein the front face of the shaft end and the stop disc located within the bearing bush are designed for a mutual punctiform arrangement against the stop disc.

20. The bearing arrangement according to claim 19, wherein the front face of the shaft end is a convex and one of a spherical shape and a spherical segment shape.

21. The bearing arrangement according to claim 17, wherein the stop disc is held tensioned in a pre-installation stage on the internal side of the bearing bush in such a manner that the stop disc can be moved in the axial direction during or by installation of the bearing arrangement in order to eliminate axial play of the rotor shaft.

22. The bearing arrangement according to claim 17, wherein the stop disc is made of one of metal and ceramic.

23. The bearing arrangement according to claim 1, wherein the bearing bush is designed as a bush open on one side.

24. The bearing arrangement according to claim 1, wherein the filling mass forming the filling body is a thermoplastic.

25. The bearing arrangement according to claim 1, wherein the filling body is a low-melt-point metal alloy.
